(19) United States
(12) Patent Application Publication
(10) Pub. No.: US 2015/0381905 A1
(43) Pub. Date: Dec. 31, 2015

(54) PHOTO BOOTH KIT

(71) Applicant: JAKKS Pacific, Inc., Santa Monica, CA (US)

(72) Inventors: Stephen Berman, Malibu, CA (US); Dominic Laurienzo, Rancho Palos Verdes, CA (US); Lizabeth Hogan, Los Angeles, CA (US)

(21) Appl. No.: 14/751,003

(22) Filed: Jun. 25, 2015

Related U.S. Application Data
(60) Provisional application No. 62/017,670, filed on Jun. 26, 2014.

(51) Int. Cl. H04N 5/272; H04N 7/18

(52) U.S. Cl. CPC H04N 5/272; H04N 7/183

(57) ABSTRACT

Described is a photo booth kit. The kit includes a frame having a. tablet mount adapted to hold a tablet computer. A cover is included that is formed to cover the frame and, together with the frame, forms a photo booth. At least one panel in the cover includes a chroma-keyed color. Party supplies and props are included. The party supplies and props are formed to depict a coordinated theme. Finally, a photo booth software application is included. The photo booth software application is operable to cause the tablet computer to obtain photos of a user in front of the panel and superimpose the user over a background that is stored in the tablet computer and rendered by the photo booth software application.

### CROSS-REFERENCE TO RELATED APPLICATIONS

This is a non-provisional application of U.S. Provisional Application No. 62/017,670, filed on Jun. 26, 2014.

### BACKGROUND OF THE INVENTION

(1) Field of Invention

The present invention relates to chroma key tools and, more particularly, to a photo booth kit that can be used for parties and other events and that includes everything needed to instantaneously provide blue or green screen effects to event participants.

(2) Description of Related Art

Chroma key tools have long been known in the art. Chroma keying is a special effects technique for compositing (layering) two images or video streams together. Blue screens or green screens are often used as background screens in which a participant stands or acts. The participant is then selectively overlayed onto a different background, which provides the effect that the participant is actually in that background. For example, a participant running in front of a green screen can then be superimposed over a background with dinosaurs. The resulting effect is that the participant appears in a composited video running from dinosaurs. While chroma keying has long been used in the special effects industry, little advances have been made in the commercial or home use market.

Thus, a continuing need exists a kit that allows a user to easily implement chroma key technology for home use or events.

### SUMMARY OF INVENTION

The present invention is directed to a photo booth kit that can be used for parties and other events and that includes everything needed to instantaneously provide chroma key effects (e.g., blue or green screen) to event participants, such as at a birthday party, wedding, etc.

The kit includes a frame having a tablet mount adapted to hold a tablet computer. A cover is included that is formed to cover the frame and, together with the frame, forms a photo booth. At least one panel in the cover includes a chroma-keyed color. Party supplies and props are included. The party supplies and props are formed to depict a coordinated theme (such as a movie theme). Finally, the kit includes instructions to download a photo booth software application. The photo booth software application is operable to cause the tablet computer to obtain photos of a user in front of the panel and superimpose the user over a background that is stored in the tablet computer and rendered by the photo booth software application.

Finally, as can be appreciated by one in the art, the present invention also comprises a method for forming and using the invention described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an illustration of a frame structure according to an embodiment;

FIG. 2A is a perspective-view illustration of a tablet mount according to an embodiment;

FIG. 2B is a top-view illustration of the tablet mount;

FIG. 2C is a side-view illustration of the tablet mount;

FIG. 3 is an illustration of the tablet mount;

FIG. 4 is an illustration of a cover according to an embodiment, depicting the cover as positioned around the frame structure; and

FIG. 5 is an illustration depicting various items that can be supplied with the photo both kit according to an embodiment.

### DETAILED DESCRIPTION

The present invention relates to chroma key tools and, more particularly, to a photo booth kit that can be used for panics and other events and that includes everything needed to instantaneously provide blue or green screen effects to event participants. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including, any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

(1) Description

The present invention is directed to a photo booth kit that can be used for parties and other events to provide chroma key effects (e.g., blue or green screen) to event participants, such as at a birthday party, wedding, etc.

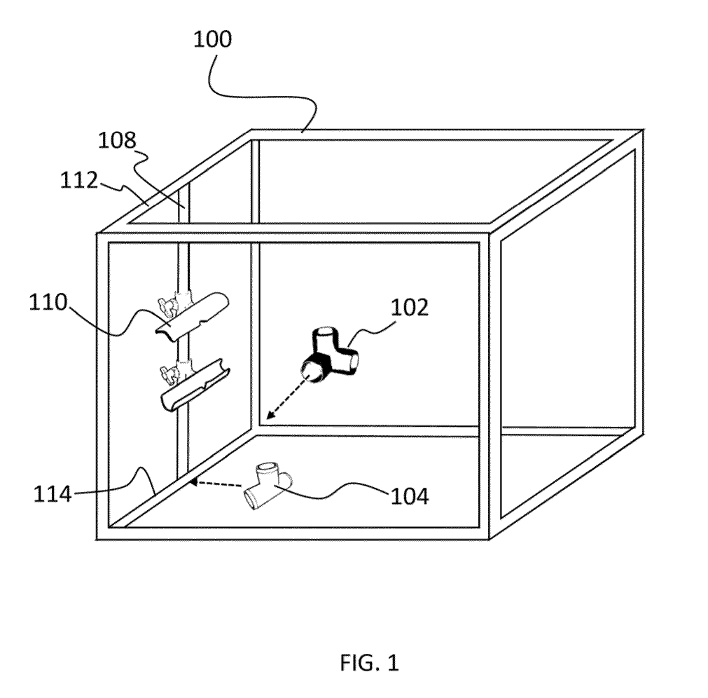

The photo booth kit includes any number of items to allow for chroma key effects. For example, the kit can be formed to include a big, rectangular cover (or any other desired shape) that is wrapped around a frame or structure, thereby forming the photo booth. As a non-limiting example as illustrated in FIG. 1, the frame structure 100 is formed to provide a frame for a covering (e.g., cover or tent). The frame structure 100 is formed of any suitable material that provides a stable frame, a non-limiting example of which includes plastic tubing tor any other tubing or structure) that is snapped together to form a rectangular tent shape (or any other desired shape). Thus, in one embodiment, the frame structure 100 is formed of tubular pipes that can be connected with each other using appropriate fittings, such as 3-way corner connectors 102 and T-shaped connectors 104 as may be required. As a non-limiting example, such tubular connections are commonly used in the art and are similar to the fittings that one might find in sprinkler PVC piping system.

To provide the chromo key effects, a photo booth software application can be included. The software application can be downloaded onto the user's smart phone or tablet computer through the interne or through any other suitable means. To provide the user the photo booth software application, the product packaging or instructions included with the photo booth kit include the relevant directions to direct the user to the appropriate site to download the photo booth software application. As a non-limiting example, the photo booth software application can be an iPad app that is available via iTunes, or any other suitable tablet and download medium. The photo booth software application includes all of the requisite software to provide the chromo key effects, such that when the user takes the photo and is standing in front of a green screen (or blue screen), the user's image is superimposed (layered) over the selected background. As understood by those skilled in the art, software applications are programs that can be loaded into a user's computing device to provide a variety of functions or features. As applied to the present invention, the photo booth software application can be loaded into a mobile device, such as a tablet computer or mobile phone. The software application uses the camera feature of the mobile device to take a picture or video of participants in the photo booth. Using commonly understood chromo key technology, the photo booth software application layers the image (of the participants) taken using the mobile device's camera over a background as selected by the participants (or a predetermined background). The composited image is then displayed to the participants and can be emailed or otherwise provided to the participant's via a desired medium, such as posted to a social media account or printed via a printer.

Chromo key technology is commonly understood by those skilled in the art Thus, the photo booth software application is, in one embodiment, a computer program product. The computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium. The “instructions” as applicable to the photo booth software application can be downloaded via the internet and include the necessary commands to cause the mobile device to take an image of participants in front of a chroma key screen (e.g., blue or green screen) and composite the images of the participants over the selected background. The photo booth software application includes a plurality of backgrounds from which a user can select from and also allows a user to selectively take a photo, via timer or instantaneous screen activated button.

The frame 100 also includes any suitable mechanism or device to hold the mobile device at the appropriate location to take images of the participants. As a non-limiting example, the frame 100 includes a tablet support 108 with one or more tablet mounts 110. The tablet support 108 is connected, for example, with and between a top portion 112 and bottom portion 114 of the frame 100. For example, the tablet support 108 is a tubular frame member that is connected with the top and bottom portions 112 and 114 of the frame using T-shaped connectors 104. The tablet mounts 110 are adjustable along the length of the tablet support 108 to allow a user to selectively position the location of the tablet mounts 110 and, thereby, selectively position the camera direction and elevation of the mobile device.

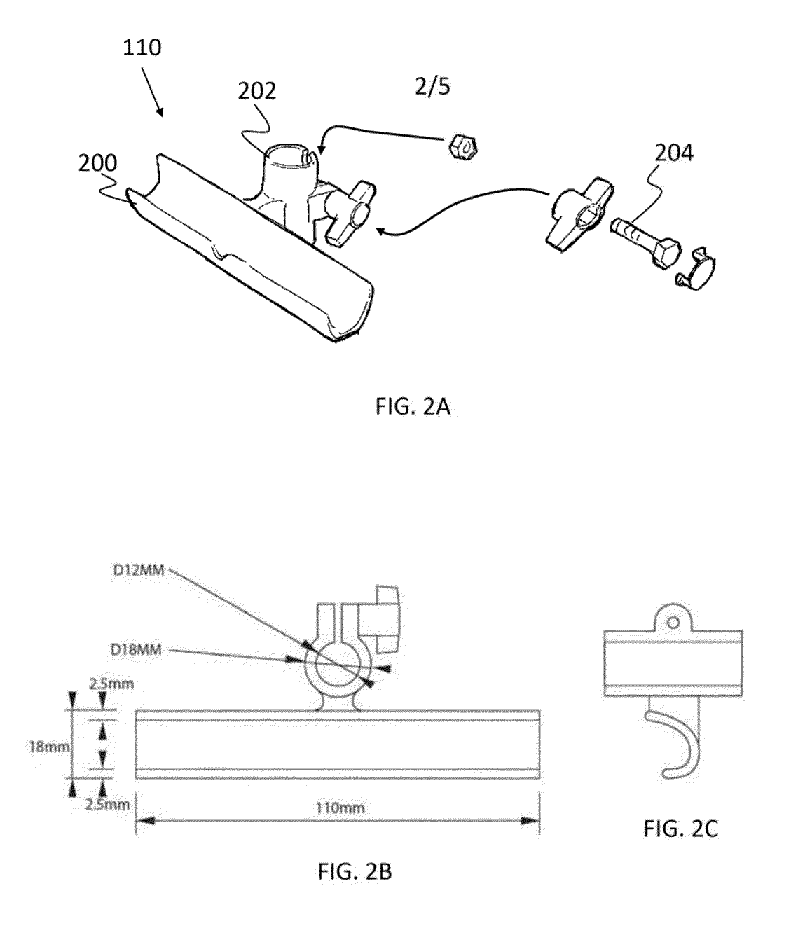

The tablet mounts 110 are any suitable mechanism or device that allow a user to selectively affix a mobile device (e.g., tablet computer) with the frame 100. As a non-limiting example and as shown in FIG. 2A, the tablet mount 110 includes a grip portion 200 and a connector sleeve 202. A tightening mechanism 204 is also included. Thus, while the connector sleeve 202 can be connected with the tablet support by passing the connector support through the connector sleeve 202, it should be understood that the connector sleeve 202 is provided as a non-limiting example of a suitable connection mechanism as any suitable connection mechanism can be employed. In one aspect, the tightening mechanism 204 is used to selectively set and fix the tablet mount 110 at the desired height along the tablet support. For further understanding, FIGS. 2B and 2C are a top and side-view, respectively, of the tablet mount 110. It should be understood that the specific dimensions as illustrated in FIG. 2B are provided as one non-limiting example of suitable dimensions; however, the invention is not intended to be limited thereto.

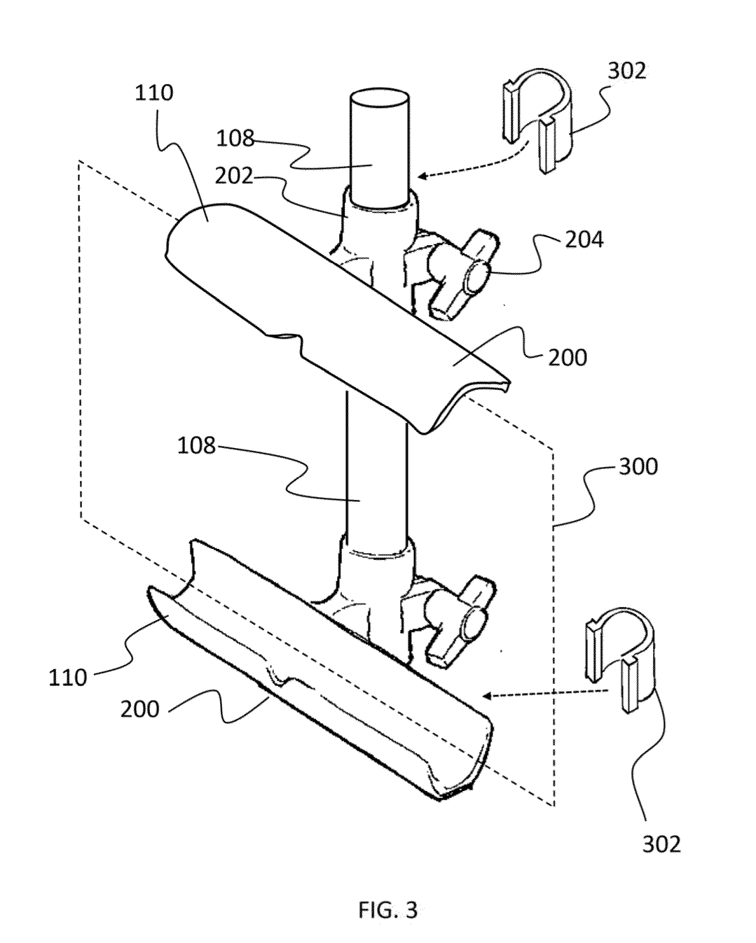

For further understanding, FIG. 3 depicts two tablet mounts 110 as affixed with a tablet support 108. As noted above, each tablet mount 110 includes a grip portion 200 and a connector sleeve 202. The grip portions 200 provide recessed surfaces that can be positioned around the top and bottom portions of a mobile device 300 to effectively hold and sandwich the mobile device 300 between the tablet mounts 110. Once set at the desired location using the tightening mechanism 204, a secondary lock can be employed to further fix the tablet mounts 110. As a non-limiting example, the secondary lock includes a pair of clips 302 that can be positioned around the tablet support 108 to further prevent the tablet mounts 110 from sliding along the tablet support 108. With the mobile device 300 secured against the tablet mounts 110, the user can selectively use the photo booth software application as loaded onto the mobile device 300.

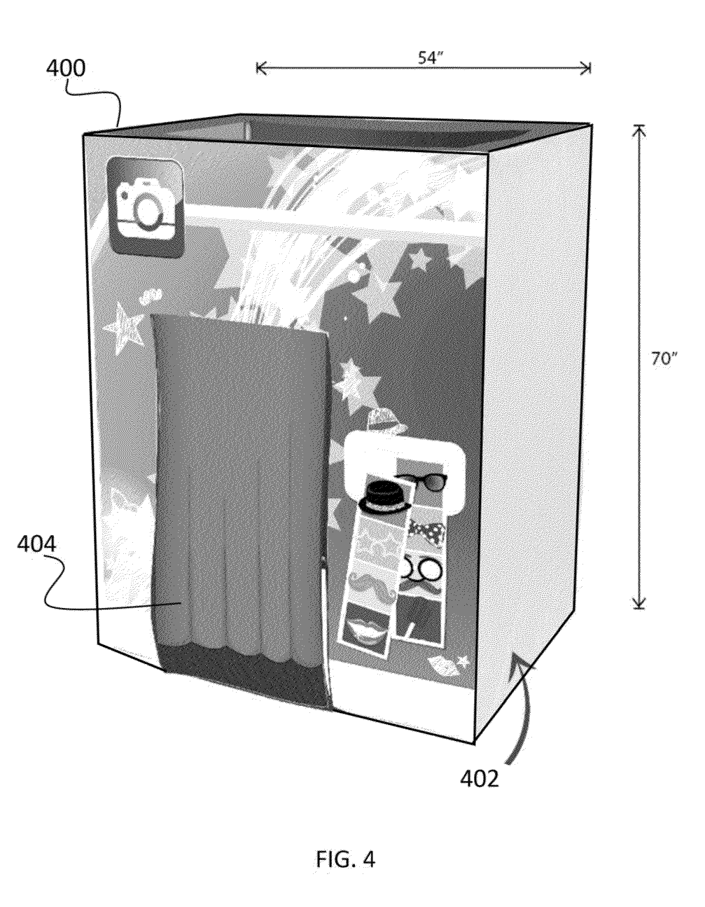

To obtain the chroma key effects as provided for by the photo booth software application, the participant needs to be positioned in front of a chroma key screen (e.g., blue screen or green screen). Thus, the photo booth kit also includes a chroma key screen. For example and as illustrated in FIG. 4, the photo booth kit includes a cover 400 that is formed to cover the frame. The cover 400 is any suitable material that, together with the frame, form a photo booth. For example, the cover 400 is formed of large rectangular plastic or cloth sheet and can be wrapped around the frame. Hook and loop fasteners (e.g., Velcro®) or any other fixture technique can be used to fasten the sheet around the frame to form the finished photo booth. Notably, at least one panel (section) 402 in the cover 400 includes a chroma keyed color (e.g., green colored panel or green screen). Although depicted on the exterior, it should be noted that the panel 402 on the interior includes the chroma keyed color.

The sheet or cover can include a door cutout 404 or passageway that allows participants to enter the photo booth. As noted above, at least one interior panel 402 of the photo booth is a color that is chromo keyed to work with a particular chroma key app. For example, at least one interior panel of the booth is a “green screen” or “blue screen.” It should be noted that the specific dimensions illustrated are provided as one example of suitable dimensions; however, it should be understood that the invention is not intended to be limited thereto.

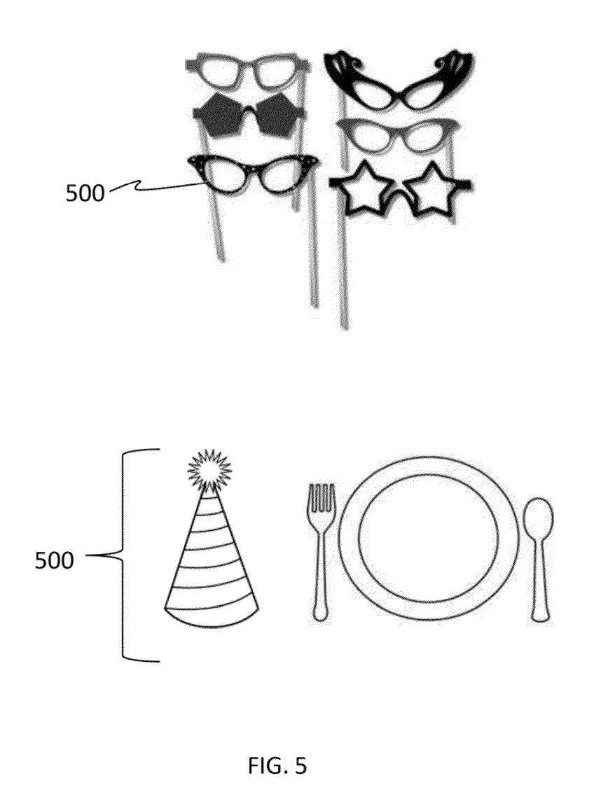

To further enhance the kit and as shown in FIG. 5, the kit can be formed to include props 500. The props 500 are any suitable props that can be worn or used by the participants in taking the photos or videos, non-limiting examples of which include hats, clothing, weapons, etc. As a non-limiting example, the props are relevant to the background scenes as stored in the tablet computer and rendered via the photo booth software application. For example, if the event is a movie themed event, then the background and props can all be coordinated with the movie theme. Further, printed photo paper and party supplies 502 (e.g., plates, cups, utensils, napkins, table cover, party bags, party favors, etc.) can also be provided with the kit. Both the photo paper and party supplies 502 can also be coordinated with the theme. Thus, the present invention is a photo booth kit that allows an event coordinator to quickly and effectively prepare and provide a photo booth to event participants. Importantly, the photo booth kit is adapted to hold a tablet or other device, with the tablet or other device having chroma key software to allow a user to take photos and/or videos and generate chroma key effects.

What is claimed:

1. A photo booth kit, comprising:
a frame, the frame having a tablet mount adapted to hold a tablet computer;
a cover, the cover formed to cover the frame and, together with the frame, form a photo booth, wherein at least one panel in the cover includes a chroma keyed color; and
instructions to download a photo booth software application, the photo booth software application being operable to cause the tablet computer to obtain an image of a participant in front of the panel and superimpose the image over a background that is stored in the tablet computer and rendered by the photo booth software application.

2. The photo booth kit, further comprising party supplies and props, the party supplies and props formed to depict a coordinated theme.

3. A photo booth kit, comprising:
a frame, the frame having a tablet mount adapted to hold a tablet computer;
a cover, the cover formed to cover the frame and together with the frame, form a photo booth, wherein at least one panel in the cover includes a chroma keyed color; and
a photo booth software application, the photo booth software application being operable to cause the tablet computer to obtain an image of a participant in front of the panel and superimpose the image over a background that is stored in the tablet computer and rendered by the photo booth software application.
